(19) United States
(12) Patent Application Publication
(10) Pub. No.: US 2006/0152495 A1
(43) Pub. Date: Jul. 13, 2006

(54) 3D input device function mapping

(76) Inventor: Bernd Gombert, Seefeld (DE)

Correspondence Address: FITZPATRICK CELLA HARPER & SCINTO, 30 ROCKEFELLER PLAZA, NEW YORK, NY, 10112, US

(21) Appl. No.: 10/513,001

(22) PCT Filed: Oct. 21, 2002
(86) PCT No.: PCT/EP02/11751

§ 371 Date: Jul. 5, 2005

Related U.S. Application Data
(60) Provisional application No. 60/365,024, filed on Mar. 12, 2002.

(51) Int. Cl. G09G 5/00

(52) U.S. Cl. 345/172

(57) ABSTRACT

A method for mapping functions of a multi-dimensional input device is proposed, wherein a graphical representation of a button or an other degree of freedom of the input device (130, 140, 150) is displayed on a screen or monitor. Furthermore at least one available driver function for the input device (130, 140, 150) is displayed. A selected function can be mapped by a user to a button or other degree of freedom of the input device (130, 140, 150) by graphically associating the specific function with the button or degree of freedom.

The present invention relates to mapping functions to a button or a other degree of freedom of a multidimensional input device, and more particularly, assigning the mapping via drag-and-drop actions.

Conventional 3D input devices offering six or more (independent) degrees of freedom are known. A conventional 3D input device often has buttons to provide extra functionality and flexibility in providing input to the computer system. The usually three rotational and translational degrees of freedom as well as these buttons are typically mapped to specific key commands.

In the conventional 3D input device, mapping a key command to a button requires the user to know the specific keystrokes required to effect the command within the software. Additionally, the user must enter these keystrokes into an interface associated with a pointing device driver software.

Requiring the user to know and enter the desired keystrokes has many disadvantages. First, application software changes, and with it, the keystrokes may change, leading to outdated and incorrect knowledge by the user. Additionally, keystrokes vary from application to application, requiring the user to learn and remember a unique set of keystrokes for each application used. The non-uniformity of keystrokes in application software requires great diligence from the user in mapping functions to the input device buttons, as well as continued monitoring to retain the validity of the assigned keystrokes. across application upgrades and software migrations.

Second, even assuming that the correct keystrokes are known, the process of indicating the correct sequence of keys to the input device driver software may introduce errors. Conventional 3D input device driver software typically requires the user to indicate shifting or auxiliary keys such as SHIFT or CONTROL by, either spelling out the key or selecting the key as a modifier when typing the key to be modified. Both methods of entering the keystrokes may lead to inadvertent errors. These errors may not be evident upon inspection and may cause the user time and money in correcting the mapping, as well as any damage done from activating an incorrect command in the application software.

Finally, conventional 3D input-device driver mapping software requires the use of additional peripherals, typically a keyboard for entering the keystroke information. In certain systems, the presence of a keyboard may not be desirable. One such system utilizes a 3D input device to control a robotic arm. When a keyboard is not desired, or present, conventional mapping software cannot function.

U.S. Pat. No. 6,169,540 B1 discloses a method and an apparatus for designing force sensations in force feedback applications. Icons representing different types of force sensations are thereby displayed in an interactive graphical toolset interface and may be allocated to a button of that interface by drag and drop. This button has thus been designed to trigger the reflex sensation when pressed, allowing the user to test force sensations.

An apparatus and method for configuring a computing device to support a plurality of pointing devices or a singular pointing device that can provide a plurality of functions are known from U.S. Pat. No. 6,204,837 B1. Thereby setting boxes are used, permitting the user to make setting selections which may be specific to each type of device.

Therefore, there is a need for an input device driver software that (1) provides a non-application-specific manner of mapping functions to buttons, (2) reduces user error in mapping functions to buttons, and (3) allows for the mapping an re-mapping of functions to input device buttons without the use of a keyboard.

Correspondingly it is the object of the present invention to propose a technique allowing an intuitive mapping of degrees of freedom or buttons of a multidimensional input device.

This object is achieved by means of the features of the independent claims. The dependent claims develop further the central idea of the present invention.

According to a first aspect of the present invention a method for mapping functions of a multi-dimensional input device can comprise the steps of:
displaying a graphical representation of a button or an other degree of freedom of the input device,
displaying at least one available driver function for the input device, and
mapping a selected function to a button or other degree of freedom of the input device by graphically associating the specific function with the button or degree of freedom.

The step of graphically associating the specific function with the button or degree of freedom can be implemented f.e. by drag-and-dropping.

According to another aspect of the present invention a multi-dimensional input device driver mapping software is proposed which supports such a method when running on a computing device.

Still further aspects of the present invention aim at a computer-readable medium and a multi-dimensional input device having a mapping configuration. In the following further features, advantages and objects conferred by the present invention will be explained with reference to the figures of the enclosed drawings.

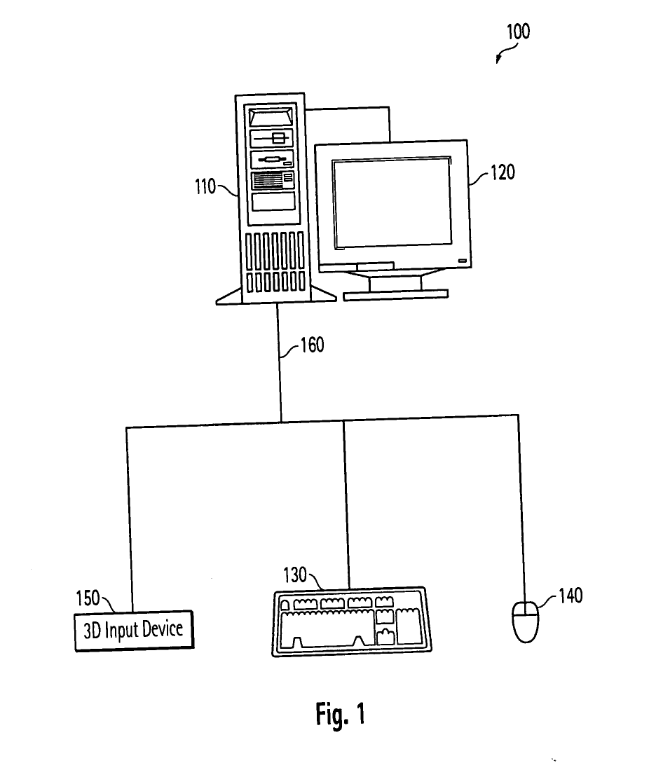

FIG. 1 illustrates a block diagram of a conventional computer system capable of utilizing the present invention.

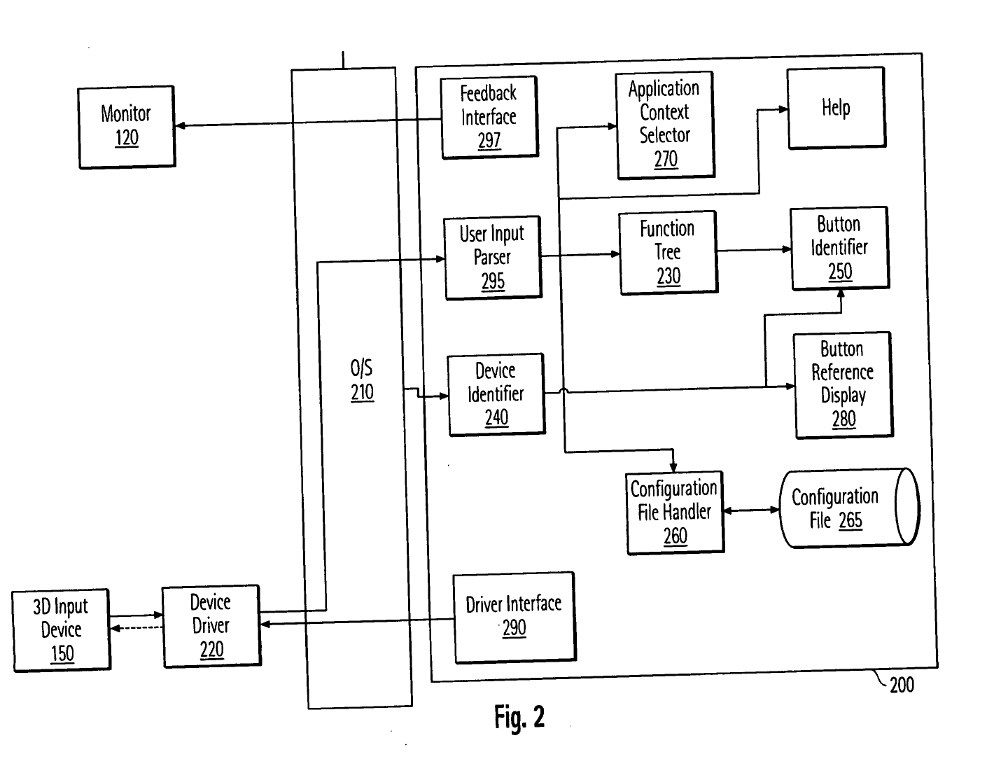

FIG. 2 is a block diagram illustrating a preferred embodiment of the mapping configuration interface and its interaction with the conventional computer system.

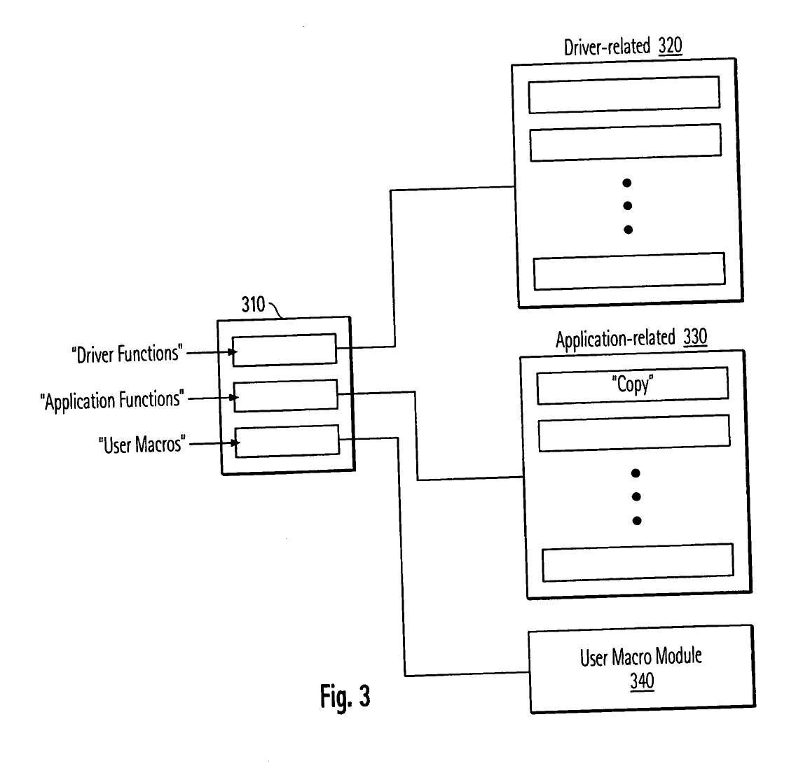

FIG. 3 illustrates a block diagram of the tree structure for the function tree 230.

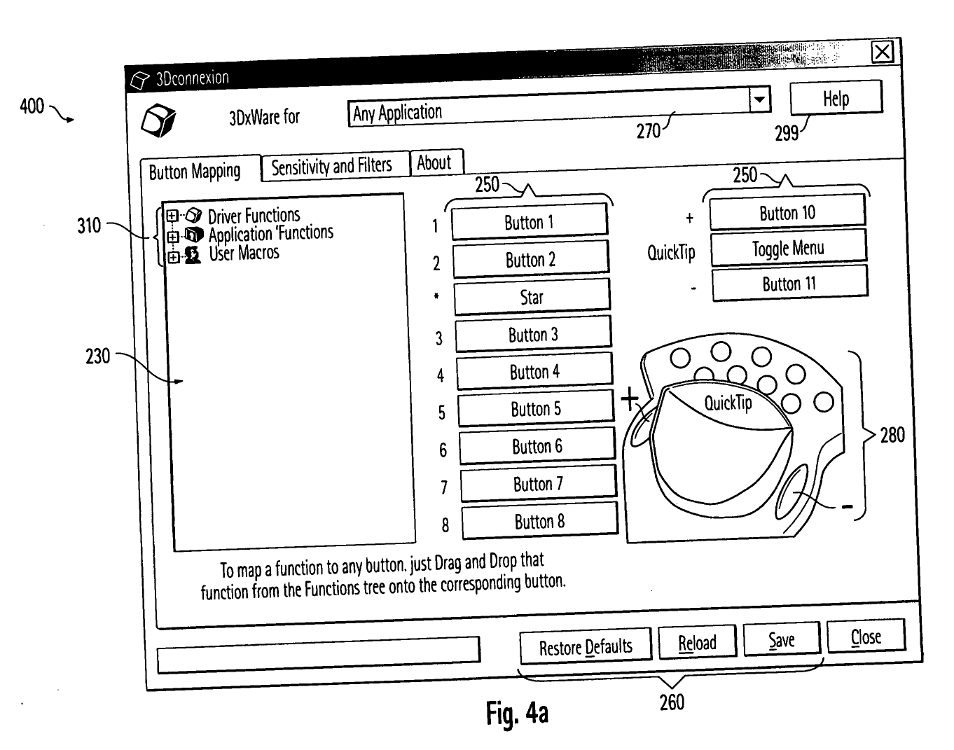

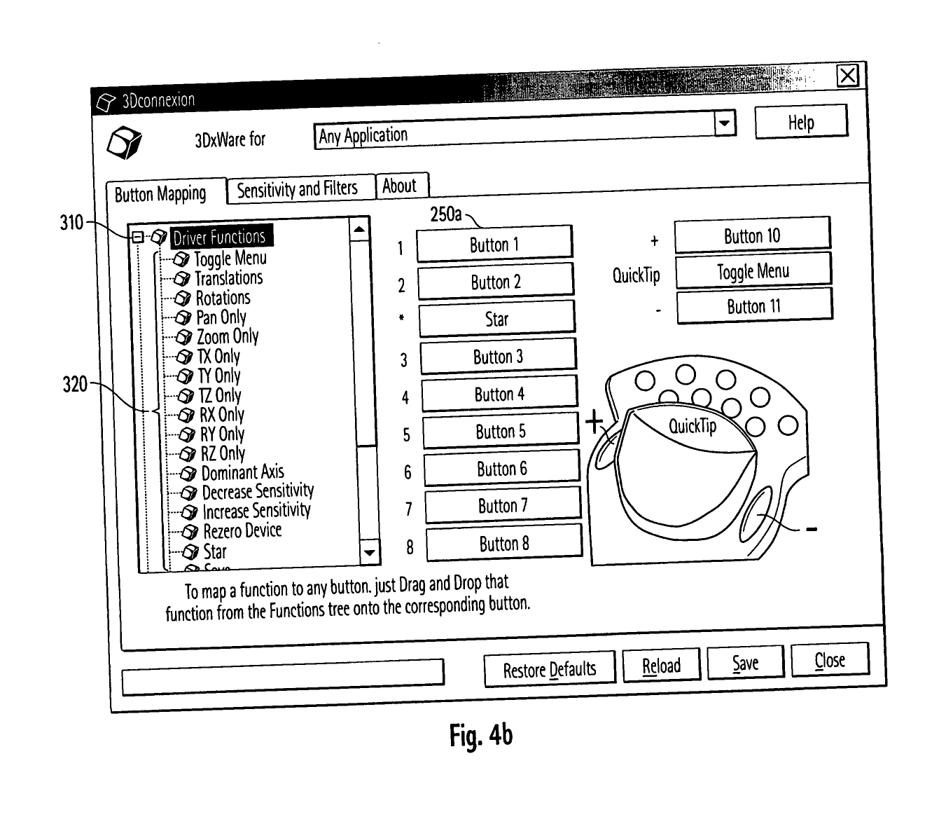

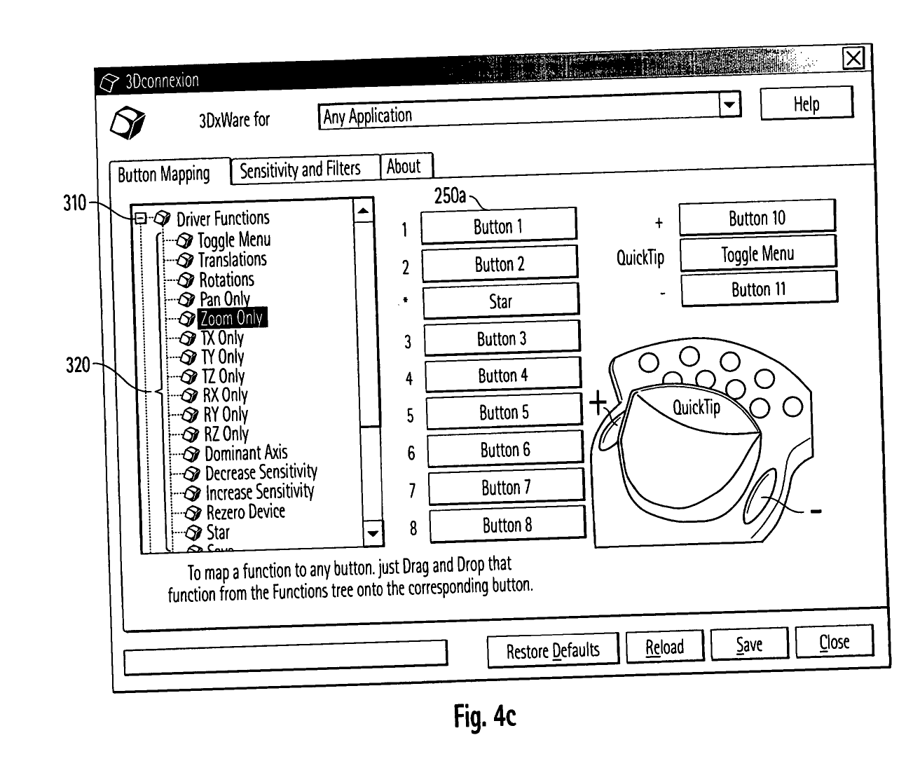

FIGS. 4a-4c illustrate the arrangement and layout of one embodiment of the mapping configuration interface.

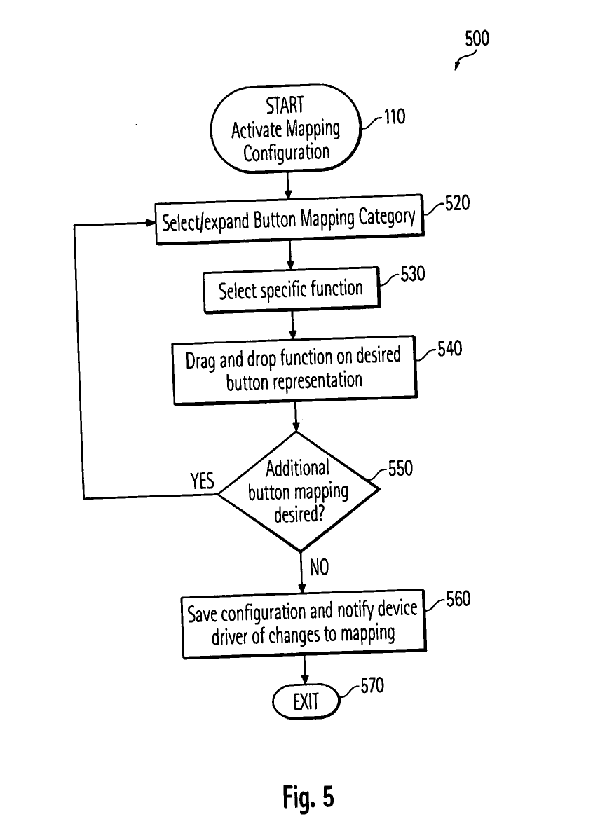

FIG. 5 illustrates a flow diagram of a method for mapping functions to buttons according to the present invention.

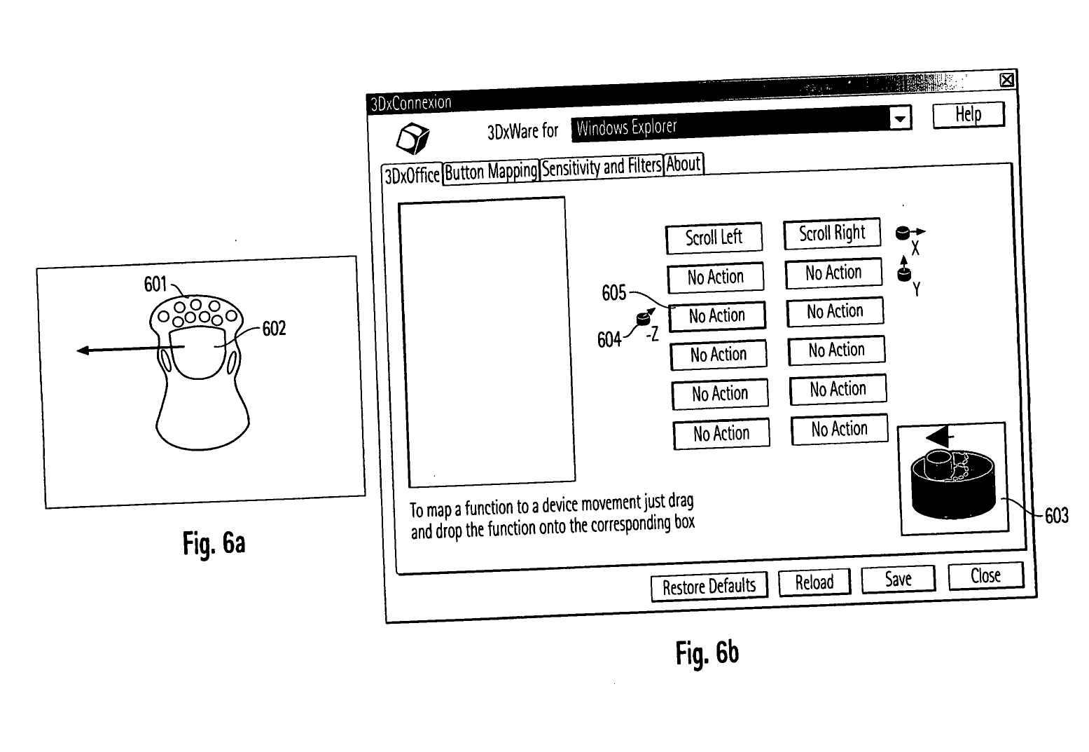

FIG. 6a,b shows a further embodiment with facilitated mapping functionality.

### DESCRIPTION OF THE EMBODIMENTS OF THE PRESENT INVENTION

The present invention is discussed with references to the Figures in which similar reference numbers of components may indicate like or similar functionality. The present invention includes software for configuring a mapping of an input button on an input device while advantageously avoiding the problems of conventional mapping software discussed above.

FIG. 1 illustrates a block diagram of a conventional computer system 100 capable of utilizing the present invention. Conventional computer system 100 includes a CPU 110, a monitor 120 (or other visual user interface), and at least one user input device, which may be a keyboard 130, a 2D mouse 140, or a multidimensional input device 150. In one embodiment the multidimensional input device 150 operates in three dimensions (3D) providing the user six or more degrees of freedom when interacting with a computer program. Multi-dimensional input device 150 is illustrated as such a 3D input device. Additionally, multi-dimensional input device 150 may be a speed and/or velocity control device.

CPU 110 generally includes a processor, a memory unit, a storage unit and at least one I/O unit (I/O bus 160). Monitor 120 is coupled to CPU 110 and is configured to display information related to programs and functions being performed by computer system 100. User input devices (130, 140, and 150) are typically communicatively coupled to the I/O unit of CPU 110 by an YO bus 160. I/O bus 160 may be either a unidirectional bus transmitting data from the input devices (130, 140, 150) to CPU 110, or may be a bi-directional bus capable of transmitting data in both directions between CPU 110 and user input devices (130, 140, 150).

Generally speaking, the present invention may be implemented as software, firmware, hardware, or a combination therein. For purposes of this discussion, the invention will be discussed in terms of a software solution, however one skilled in the art will recognize the applicability to firmware and hardware solutions as well. The present invention aids the CPU 110 in the interpretation of an input signal on PO bus 160 corresponding to a button on a user input device 130, 140, 150 by configuring the mapping of a software function to be selectively activated by a press of the button. Additionally, the present invention communicates with the user by providing feedback on monitor 120 to aid in the configuration of the function mapping.

FIG. 2 is a block diagram illustrating a preferred embodiment of the mapping configuration interface 200 and its interaction with CPU 110, monitor 120, and 3D input device 150. As illustrated in FIG. 2, CPU 110 includes an operating system 210 which resides in the memory unit of CPU 110 and directs the operation of hardware and software associated with CPU 110. CPU 110 also includes a device driver 220 for communicating with 3D input device 150 on I/O bus 160 (see FIG. 1). The device driver 220 interprets the signals from 3D input device 150 for operating system 210. Operating system 210 also generally handles communications with monitor 120.

Mapping configuration interface 200 is communicatively coupled to the operating system 210 and includes a function tree 230, a device identifier 240, a button identifier 250, a configuration file handler 260, a configuration file 265, an application context selector, a button reference display 280, a driver interface 290, a user input parser 295, a feed back interface 297, and an optional help module 299. User input parser 295 receives user input from the 3D input device 150 via device driver 220 and operating system 210. The user input parser 295 is coupled to all user-actionable sections of the mapping configuration interface 200. The user-actionable sections include application context selector 270, function tree 230, optional help module 299, and configuration file handler 260. Application context selector 270 also receives information from the operating system 210 as to which application is currently being run. Function tree 230 is further coupled to button identifier 250. Configuration file handler 260 is communicatively coupled with configuration file 265 which is stored in CPU 110s storage unit. Device identifier 240 is coupled to the operating system 210 for receiving information on specific type of 3D input device 150 which is to be configured. Device identifier 240 is further coupled to button identifier 250 and button reference display 280. Feedback interface 297 is coupled to the operating system 210 in order to provide visual feedback from button and axis mapping configuration interface 200 as well as a 3d graphical feedback of the actual cap (602 in FIGS. 6a, 6b) movement to the user via monitor 120. Additionally, other types of feedback may be utilised such as sound. Finally, driver interface 290 is coupled to the device driver 200 via operating system 210 to inform the device driver 200 of changes in the button or axis mapping.

The mapping configuration interface 200 operates as follows. Reference will be made to FIG. 5 which illustrates a flow diagram of a method 500 for mapping functions to buttons or axes according to the present invention. Reference numbers relating to FIG. 5 will be presented in parenthesis. A user's desire to configure the mapping of a button or axis of the 3D input device 150 is received by operating system 210 via an input device such as 3d input device 150, keyboard 130, or 2D mouse 140. Operating system 210 activates mapping configuration interface 200 (510). Using an input device, the user selects a main category from the function tree 230 (520). The function tree 230 includes a hierarchical listing of function definitions for mapping to the 3D input device 150 buttons. Once the main category is selected, the user selects a specific function and its definition from the expanded hierarchical listing (530). The user indicates a desire to map the selected function to a specific device button or axis by drag-and-dropping the specific function onto a representation of the button or axis provided by button identifier 250 (540). Button identifier 250 receives a device identification from device identifier 240, which corresponds to the specific device to be configured. Based on the device identification, button identifier 250 generates a graphical representation, or target, for each configurable button according to the device identification. By dragging the function onto these targets, the user identifies both the function and location to be mapped. In one embodiment, the drag-and-drop actions are performed via the 3D input device 150. In alternate embodiments, the drag-and-drop actions may be performed by a mouse, keyboard, touch screen, by voice activation, or by tracking user eye movement.

Mapping configuration interface 200 also includes the application context selector 270 that allows the user to configure the input device buttons differently for each application used on the system 100. Additionally, application context selector 270 receives input from the operating system 210 as to which application is currently being used to ensure that the correct mapping is provided to the device driver 220.

To facilitate easier configuration changes, mapping configuration interface 200 uses the configuration file handler 260 and configuration file 265 in order to store and back up the user-defined button mappings. Configuration file handler 260 allows configurations to be saved to configuration file 265 as well as allows configurations to be 1:1 read back out of configuration file 265 to restore a backed-up configuration or to aid in the promulgation of a uniform configuration across several computer systems 100.

Once all desired functions are mapped to keys (550) or axes for each application, the configuration is saved to the configuration file 250 via configuration file handler 260 and the device driver 220 is notified of the changes to the button/axis mapping via driver interface 290 (560). Upon successful device driver notification, the mapping configuration interface may be exited by the operating system 210 or user (570).

FIG. 3 illustrates a block diagram of the tree structure for function tree 230. As illustrated, function tree 230 includes a main category selection 310 and three sub-categories 320, 330, 340. Main category selection 310 is illustrated here as having three categories, “Driver Functions”, “Application Functions”, and “User Macros”. When one of the three main categories is selected, the function tree 230 further displays a sub-category function listing 320, 330, 340 corresponding to the category selection.

In FIG. 3, the function listing for “Driver Functions” includes a listing of functions related to the operation of the device driver 220. More specifically, the driver-related listing 320 includes the key-stroke or programmatic instructions required to instruct the device driver 220 to perform that function.

Likewise, selecting the “Application Functions” selection opens an application-related listing 330. The Application-related 330 listing includes keystrokes or programmatic instructions required to instruct the desired application to perform that function. An example of an application-related function may be the “fit-to view” function, which centralizes the object to the center of the screen. With most of the CAD applications a similar command can be accessed by either pressing a certain button of the toolbar, or by selecting the command through the menu. The “fit-to view” listing in the application-related listing 330 would include an instruction for the device to simulate the related application-specific keystroke when the mapped button is pressed.

The third main category in main category selection 310 is “User Macros”. Selecting this main category leads to activation of a user macro module 340. User macro module 340 displays previously made user commands, as well as provides the ability to map functions or keystrokes not currently listed in the driver-related listing 320 or application-related listing 330.

While FIG. 3 illustrates the function tree 230 structure as containing only three main categories, one skilled in the art will recognize that any number of main categories may exist within main category selection 310. Additional sets of main categories and their attendant sub-categories and function definitions may be provided by the device driver author or via third party developers to provide definitions for functions contained in their own software. As noted above, while most functions in the main categories will be pre-defined by the author of the driver software or by third party developers, the mapping configuration interface also allows a user to create their own function definitions for use with the 3D input device 150.

One of the primary advantages of using a drag-and-drop system combined with the function tree 230, is that the user no longer needs to know the underlying commands to select the function for mapping. This allows for a complete transference of functionality from one software application to another, as well as safeguarding against changes to the commands when software is upgraded. Additionally, by using a drag-and-drop system, mapping configurations may be made on systems 100 which do not utilize keyboard 130 since keystrokes do not have to be entered into the configuration interface.

FIGS. 4a-4c illustrate the arrangement of one embodiment 400 of the mapping configuration interface 200 as presented to the user. Embodiment 400 includes the following visible elements. At the top of the window, (generally mapping configuration interface embodiment 400), the application context selector 270 is provided as a drop-down window. Application context selector 270 is configured to receive a listing of possible applications from operating system 210 to display in the drop down window for selection by user when configuration for a specific application is desired. To the right of the application context selector 270 is the help module 299 button. The help module 299 may provide additional information regarding the operation and options associated with the mapping configuration interface 400.

In the middle section of the window 400, on the left hand side, resides the function tree 230 interface. In FIG. 4a the function tree 230 is illustrated as providing access to the main category selection 310, which is present when the user has not selected a main category. To the right of the function tree 230 the button identifier 250 has generated two columns of button targets each associated with a button on the 3D input device 150. To help the user determine which functions are already mapped to buttons, the targets themselves are labeled with the corresponding function. As illustrated, the 3D input device 150 has 12 configurable buttons denoted as 1-8,+,−,*, and QuickTip, in FIG. 4a, no functions have been assigned and the targets are labeled with the button names. To aid the user in determining the position and identification of each button, button reference display 280 displays a graphical representation of the 3D device next to the button targets generated by button identifier 250. Button reference display 280 receives input from device identifier 240 to ensure that the graphical representation displayed corresponds to the 3D input device being configured.

At the bottom of the window 400 configuration file handler 260 presents three buttons for user control over the configuration file 265. These buttons include “Restore Defaults”, “Reload”, and “Save”. “Restore Defaults” allows the user to reset the mapping configuration to the factory settings, which are permanently stored in the mapping configuration interface 400. “Reload” allows the user to select a configuration file to load in place of the changes made to the configuration since the last save. This in effect allows a user to “undo” mistakes in configuring the 3D input device. Finally, “Save” allows the user to confirm the changes made to the configuration and signals the mapping configuration interface 400 to communication the changed mapping settings to the device driver 220 via driver interface 290. A “Close” button is also provide along side the configuration file handler 260 interface to allow the user to exit the program at will.

FIGS. 4b and 4c are provided merely to illustrate the visual changes associated with selecting and drag-and-dropping a function on a button. In FIG. 4b, the user has chosen to expand the “Driver Functions” main category from the function tree 230 main category selection 310. The mapping configuration interface 400 displays the content of the associated driver-related sub-category 320. FIG. 4c illustrates the result of a successful assignment of the “Zoom Only” function from driver-related sub-category 320 to Button 1 (referenced as 250a). Notice that the description in the target area for Button 1 (250a) has changed from “Button 1” in FIG. 4b to “Zoom Only” in FIG. 4c. Button identifier 250 regenerates the targets once a mapping selection has been made to indicate to the user that the function has been assigned to a particular button. With reference to FIGS. 6a and 6b a further embodiment of the present invention having a facilitated mapping functionality will now be explained.

According to this embodiment, if a multi-dimensional input device 601 is manipulated, for example by moving a cap 602 translationally to the left as shown in FIG. 6a, this degree of freedom is schematically graphically displayed 603. Further on, this degree of freedom “-z” is graphically associated with the corresponding field for mapping (604).

Finally this degree of freedom is pre-selected upon corresponding “real” activation of the input device and activated for a following mapping process carried out by the user f.e. by means of drag-and-dropping.

The same functionality is also possible for buttons, wheels etc. of the input device, i.e. upon “real” manipulation” of these “degrees of freedom” they are automatically displayed and pre-selected for a subsequent mapping.

Therefore, even if a user is not aware of the nature and correct designations of the degrees of freedom and buttons of the multi-dimensional input device 601, it is sufficient for a mapping process to manipulate the sensor (input device 601) in one degree of freedom to select this degree of freedom for a following mapping process.

It is obvious that this intuitive activation of a degree of freedom facilitates the selection of a degree of freedom to be mapped.

This intuitive mapping and selection is further promoted by the graphical 3D Animation 603 giving the user a “real tine” visual feedback of the manipulation he is about toe effect.

While the invention has been discussed with reference to a particular embodiment and interface design, one skilled in the art will recognise that other embodiments and layouts may exist without exceeding the spirit and scope of the present invention.

1. A method for mapping functions of a multi-dimensional input device, operatively connected to a monitor, the method comprising the following steps:
displaying a graphical representation of a button or an other degree of freedom of the input device (130, 140, 150),
displaying at least one available driver function for the input device (130, 140, 150), and
mapping a selected function to a button or other degree of freedom of the input device (130, 140, 150) by graphically associating the specific function with the button or degree of freedom.

2. A method-according to claim 1, characterized in that the driver function is an event triggered upon activation of the associated button or other degree of freedom of the input device (130, 140, 150).

3. A method according to claim 1 or 2, characterized in that the step of graphically associating the specific function with the button or degree of freedom is implemented by drag-and-dropping.

4. A method according to anyone of the preceding claims, characterized in that upon an event, the buttons and/or other degrees of freedom of the input device (130, 140, 150) are automatically identified (240) and displayed.

5. A method according to anyone of the preceding claims, characterized in that upon an event, the buttons and/or other degrees of freedom of the input device (130, 140, 150) are automatically named.

6. A method according to anyone of the preceding claims, characterized in that the mapping is carried out application-selective, i.e. an application program is associated with each mapping.

7. A method according to claim 6, characterized in that available application programs are identified and displayed for the mapping.

8. A method according to claim 7, characterized in that only running application programs are identified and displayed for the mapping.

9. A method according to anyone of the preceding claims, characterized in that the mapping is stored in a configuration file (265) such that it can be re-used throughout a network.

10. A method according to anyone of the preceding claims, characterized in that the mapping is stored in a device driver (220).

11. A method according to claim 9 or 10, characterized in that an application program is stored associated with a mapping.

12. A method according to anyone of the preceding claims,. characterized in that when physically manipulating the input device in a degree-of-freedom, the manipulated degree-of-freedom is graphically illustrated to facilitate the mapping operation.

13. A method according to claim 12, characterized in that the graphical illustration is carried out by means of a 3d -graphical feedback.

14. A method according to anyone of the preceding claims, characterized in that when physically manipulating the input device in a degree-of-freedom, the manipulated degree-of-freedom is activated for a following mapping operation.

15. A multi-dimensional input device driver mapping software, characterized in that it supports a method according to anyone of the preceding claims when running on a computing device.

16. A computer-readable medium characterized in that it has recorded thereon a software according to claim 14.

17. A multi-dimensional input device having a mapping configuration module (200), the mapping configuration module (200) comprising:
a feedback interface (297) for controlling a display device (120) to display a graphical representation of a button or other degree of freedom of the input device (130, 140, 150), and to display at least one available driver function (220) for the input device (130, 140, 150), and
a configuration file (265) for storing mappings of a selected function to a button or other degree of freedom of the input device (130, 140, 150), the mapping being effected by graphically associating the specific function with the button or degree of freedom.

18. A device according to claim 17, characterized in that the graphical association of the specific function with the button or degree of freedom is implemented by drag-and-dropping.

19. A device according to anyone of claims 17 or 18, characterized by a device identifier (240) for identifying and displaying, upon an event, the buttons and/or other degrees of freedom of the input device (130, 140, 150).

20. A device according to anyone of claims 17 to 19, characterized by an application context selector (270) for associating an application program with each mapping.

21. A device according to anyone of claims 17 to 20, characterized in that the mapping is stored in a configuration file (265) such that it can be re-used throughout a network.

22. A device according to claim 21, characterized in that an application program is stored in association with the mapping.
